(19) United States
(12) Patent Application Publication
(10) Pub. No.: US 2010/0204927 A1
(43) Pub. Date: Aug. 12, 2010

(54) ATOM PROBE DATA PROCESSES AND ASSOCIATED SYSTEMS

(75) Inventors: Brian P. Geiser, Hartland, WI (US); Thomas F. Kelly, Madison, WI (US); Jason Schneir, Madison, WI (US); Jay P. Roberts, Madison, WI (US); David J. Larson, Madison, WI (US); Scott A. Wiener, Mount Horeb, WI (US)

Correspondence Address: PERKINS COIE LLP;PATENT-SEA, P.O. BOX 1247, SEATTLE, WA, 98111-1247, US

(73) Assignee: IMAGO SCIENTIFIC INSTRUMENTS CORPORATION, Madison, WI (US)

(21) Appl. No.: 12/296,700

(22) PCT Filed: Apr. 12, 2007
(86) PCT No.: PCT/US2007/066570

§ 371 Date: Mar. 13, 2009

Related U.S. Application Data
(60) Provisional application No. 60/791,237, filed on Apr. 12, 2006.

(51) Int. Cl. G06F 19/00; G06T 15/00; G01N 31/00

(52) U.S. Cl. 702/27; 345/419

(57) ABSTRACT

The present invention relates to atom probe data processes and associated systems. Aspects of the invention are directed toward a computing system configured to process atom probe data that includes a data set receiving component configured to receive a first three-dimensional data set. The first three-dimensional data set has a first data element structure and is based on data collected from performing an atom probe process on a portion of an atom probe specimen. The system further includes a data set constructing component configured to create a second three-dimensional data set having a second data element structure different than the first data element structure. In selected embodiments, the system can further include a Fourier Transform component configured to perform a Fourier Transform on a portion of the second three-dimensional data set.

### CROSS-REFERENCE TO RELATED APPLICATION(S)

This application claims the benefit of U.S. Provisional Patent Application No. 60/791,237, filed Apr. 12, 2006, entitled IMAGING, VISUALIZING, AND/OR ANALYZING ATOMIC STRUCTURES, which is fully incorporated herein by reference.

### TECHNICAL FIELD

Embodiments of the present invention relate to atom probe data processes and associated systems.

### BACKGROUND

An atom probe (e.g., atom probe microscope) is a device which allows specimens to be analyzed on an atomic level. For example, a typical atom probe includes a specimen mount, an electrode, and a detector. During analysis, a specimen is carried by the specimen mount and a positive electrical charge (e.g., a baseline voltage) is applied to the specimen. The detector is spaced apart from the specimen and is negatively charged. The electrode is located between the specimen and the detector, and is either grounded or negatively charged. A positive electrical pulse (above the baseline voltage) and/or a laser pulse (e.g., photonic energy) are intermittently applied to the specimen. Alternately, a negative pulse can be applied to the electrode. Occasionally (e.g., one time in 100 pulses) a single atom is ionized near the tip of the specimen. The ionized atom(s) separate or “evaporate” (e.g., field evaporate) from the surface, pass though an aperture in the electrode, and impact the surface of the detector. The elemental identity of an ionized atom can be determined by measuring its time of flight between the surface of the specimen and the detector, which varies based on the mass/charge ratio of the ionized atom. The location of the ionized atom on the surface of the specimen can be determined by measuring the location of the atom's impact on the detector. Accordingly, as the specimen is evaporated, a three-dimensional map of the specimen's constituents can be constructed.

### SUMMARY

The present invention is directed generally toward atom probe data and associated systems and methods. Aspects of the invention are directed toward a computing system configured to process atom probe data that includes an atom probe controlling component configured to control an atom probe process to (a) evaporate atoms from the portion of the specimen and (b) collect time of flight and position data for the evaporated atoms. The system further includes an initial receiving component configured to receive the time of flight and position data and a first data set constructing component configured to construct the first three-dimensional data set from at least a portion of the time of flight and position data. The first three-dimensional data set can be a three-dimensional array. The system still further includes a data set receiving component configured to receive the first three-dimensional data set that has a first data element structure. The system yet further includes a second data set constructing component configured to create a second three-dimensional data set from at least a portion of the first three-dimensional data set by changing the location of a data element in the first three-dimensional data set, adding a data element to the first three-dimensional data set, and/or removing a data element from the first three-dimensional data set so that the second three-dimensional data set has a second data element structure different from the first data element structure.

Other aspects of the invention are directed toward a computing system configured to process atom probe data that includes a data set receiving component configured to receive a first three-dimensional data set. The first three-dimensional data set has a first data element structure and is based on data collected from performing an atom probe process on a portion of an atom probe specimen. The system further includes a data set constructing component configured to create a second three-dimensional data set having a second data element structure. The second data element structure can be different than the first data element structure and can be based on a characteristic associated with the atom probe specimen and/or the atom probe process. In selected embodiments, the system can further include a Fourier Transform component configured to perform a Fourier Transform on a portion of the second three-dimensional data set to produce a transform result, to process the transform result, and to perform an inverse Fourier Transform on the processed transform result to produce a third three-dimensional data set associated with the portion of the second three-dimensional data set.

Still other aspects of the invention are directed toward a method in a computing environment for processing atom probe data that includes receiving a first three-dimensional data set. The first three-dimensional data set has a first data element structure and is based on data collected from performing an atom probe process on a portion of an atom probe specimen. The method further includes creating a second three-dimensional data set having a second data element structure. The second data element structure can be different than the first data element structure and can be based on a characteristic associated with the atom probe specimen and/or the atom probe process.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a partially schematic illustration of an atom probe device that in accordance with embodiments of the invention.

FIG. 2 is a partially schematic illustration of the computing system shown in FIG. 1 in accordance with selected embodiments of the invention.

FIG. 3 is a flow diagram illustrating a method for processing atom probe data gathered from evaporating a portion of a specimen in accordance with certain embodiments of the invention.

FIG. 4 is a partially schematic illustration of a three-dimensional map in accordance with certain embodiments of the invention.

FIG. 5 is a partially schematic illustration of a portion of a three-dimensional numerical array in accordance with another embodiment of the invention.

FIG. 6 is a partially schematic illustration of a three-dimensional map in accordance with other embodiments of the invention.

FIG. 7 is a partially schematic illustration of a histogram in accordance with selected embodiments of the invention.

FIG. 8 is a partially schematic illustration of a histogram in accordance with other embodiments of the invention.

FIG. 9 is a partially schematic illustration of a histogram in accordance with still other embodiments of the invention.

FIG. 10 is a partially schematic illustration of a three-dimensional map in accordance with yet other embodiments of the invention.

FIG. 11 is a partially schematic illustration of a histogram in accordance with still other embodiments of the invention.

### DETAILED DESCRIPTION

In the following description, numerous specific details are provided in order to give a thorough understanding of embodiments of the invention. One skilled in the relevant art will recognize, however, that the invention may be practiced without one or more of the specific details, or with other methods, components, materials, etc. In other instances, well known structures, materials, or operations are not shown or described in order to avoid obscuring aspects of the invention.

References throughout the specification to “one embodiment” or “an embodiment” means that a particular feature, structure, or characteristic described in connection with the embodiment is included in at least one embodiment of the present invention. Thus, the appearances of the phrase “in one embodiment” or “in an embodiment” in various places throughout the specification are not necessarily all referring to the same embodiment. Furthermore, the particular features, structures, or characteristics may be combined in any suitable manner in one or more embodiments.

Accordingly, various embodiments of the invention are described below. First, the structure and operation of atom probe devices are discussed. Then, various systems and methods for processing atom probe data are described.

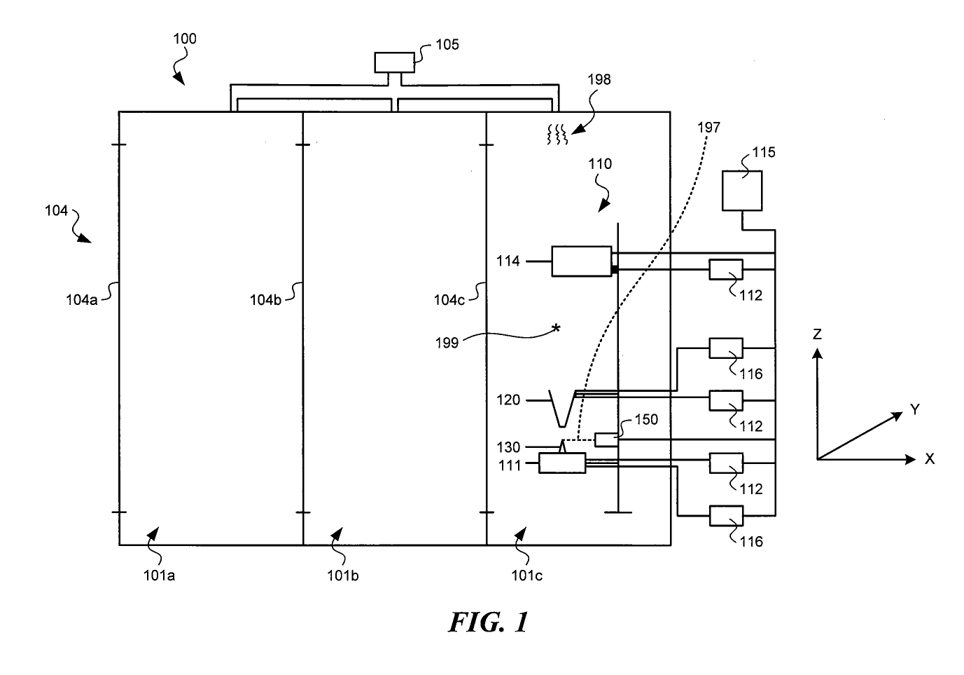

FIG. 1 is a partially schematic illustration of an atom probe device 100 in accordance with embodiments of the invention. In the illustrated embodiment, the atom probe device 100 includes a load lock chamber 101a, a buffer chamber 101b, and an analysis chamber 101c (shown collectively as chambers 101). The atom probe device 100 also includes a computing system 115 and an atom probe assembly 110 having a specimen mount 111, an atom probe electrode 120, a detector 114, and an emitting device 150 (e.g., an emitting device configured to emit laser or photonic energy). The mount 111, electrode 120, and detector 114 can be operatively coupled to electrical sources 112. The electrode 120 and mount 111 can also be operatively coupled to temperature control devices 116 (e.g., cold/hot fingers that can provide contact cooling/heating to the atom probe electrode 120 and/or a specimen 130 carried by the mount 111). The emitting device 150, the detector 114, the voltage sources 112, and the temperature control devices 116 can be operatively coupled to the computing system 115, which can control the analysis process, atom probe device operation, data analysis, image display, and/or other types of data manipulation.

In the illustrated embodiment, each chamber 101 is operatively coupled to a fluid control system 105 (e.g., a vacuum pump, turbo molecular pump, and/or an ion pump) that is capable of lowering the pressure in the chambers 101 individually. Additionally, the atom probe device 100 can include sealable passageways 104 (e.g., gate valves) positioned in the walls of the chambers 101 that allow items to be placed in, removed from, and/or transferred between the chambers 101. In the illustrated embodiment, a first passageway 104a is positioned between the interior of the load lock chamber 101a and the exterior of the atom probe device 100, a second passageway 104b is positioned between the interior of the load lock chamber 101a and the interior of the buffer chamber 101b, and a third passageway 104c is positioned between the interior of the buffer chamber 101b and the interior of the analysis chamber 101c.

In FIG. 1, a specimen can be placed in the load lock chamber 101a via the first passageway 104a. All of the passageways 104 can be sealed and the fluid control system 105 can lower the pressure in the load lock chamber 101a (e.g., reduce the pressure to 10⁻⁶-10⁻⁷ torr). The pressure in the buffer chamber 101b can be set at approximately the same or a lower pressure than the load lock chamber 101a. The second passageway 104b can be opened, the specimen 130 can be transferred to the buffer chamber 101b, and the second and third passageways 104b and 104c can be sealed.

The fluid control system 105 can then lower the pressure in the buffer chamber 101b (e.g., reduce the pressure to 10⁻⁸-10⁻⁹ torr). The pressure in the analysis chamber 101c can be set at approximately the same or a lower pressure than the buffer chamber 101b. The third passageway 104c can be opened, the specimen 130 can be transferred to the analysis chamber 101c, and the third passageway 104c can be sealed. The fluid control system 105 can then reduce the pressure in the analysis chamber 101c (e.g., the pressure can be lowered to 10⁻¹⁰-10⁻¹¹ torr) prior to analysis of the specimen 130. In the illustrated embodiment, the fluid control system 105 can also be used to introduce selected fluids 198 (e.g., gases and/or liquid) and/or to control the composition of fluid in various atom probe chambers 101.

During analysis of the specimen 130, a positive electrical charge (e.g., a bias voltage or bias energy) can be applied to the specimen. The detector can be grounded or negatively charged and the electrode can be either grounded or negatively charged. A positive electrical pulse (e.g., an increase above the baseline energy or voltage) can be intermittently applied to the specimen 130 or a negative electrical pulse can be applied to the electrode 120. The electric field(s) created by the electrical charges can provide energy to ionize one or more atom(s) on the surface of the specimen 130. These ionized atom(s) 199 can separate or “evaporate” (e.g., field-evaporated by the bias energy and/or the pulse energy) from the surface, pass through an aperture in the electrode 120, and impact the surface of the detector 114. As the specimen 130 is evaporated, a three-dimensional map of the specimen's constituents can be constructed (e.g., an image or compositional image can be created), for example, via data analysis/processing and/or the computing system 115. In other embodiments, the bias energy can include the energy difference (e.g., electrical potential and/or other type(s) of energy differential) between the specimen and the detector and/or the electrode when no pulse energy is present.

In certain embodiments, laser or photonic energy from the emitting device 150 can be used to emit an emission 197 (e.g., photons or laser light) to thermally pulse a portion of the specimen 130 to assist with the evaporation process (e.g., the removal of ionized atoms). This laser pulse can be in lieu of the electrical pulse discussed above or in addition to the electrical pulse. The total energy above the bias energy (e.g., a photonic energy pulse such as a laser pulse, an electrical pulse, an electron beam or packet, an ion beam, or some other suitable pulsed energy source) represents the pulse energy. The rate at which the pulse energy is applied is the pulse frequency.

As discussed above, the computing system 115 can control the analysis process, atom probe device operation, data processing, data analysis, image display, and/or other types of data manipulation. The computing device or computing system 115 may include a central processing unit, memory, input devices (e.g., keyboard and pointing devices), output devices (e.g., display devices), and storage devices (e.g., disk drives). The memory and storage devices can be computer-readable media that may be encoded with computer-executable instructions that implement the system (e.g., a computer-readable medium that contains the instructions). Additionally, in selected embodiments memory and storage devices can be encoded with data (e.g., data collected from an atom probe process, data used in processing the atom probe data, and/or data used in conjunction with the atom probe data). Furthermore, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras or other types of imagers, network PCs, minicomputers, mainframe computers, distributed computing environments that include any of the above systems or devices, and so on. The system may also be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, in certain embodiments a portion of computer-executable instructions can be executed on a selected computer, data can be transferred to another computer (e.g., via a network connection or via a portable computer readable medium such as a disk), and one or more additional portions of the computer-executable instructions can be performed on the data by the other computer.

In other embodiments, the atom probe device 100 can have more, fewer, and/or other arrangements of components. For example, in certain embodiments the atom probe device 100 can include more or fewer chambers, or no chambers. In other embodiments, the atom probe device can include multiple atom probe electrodes 120 and/or electrode(s) 120 having different configurations/placements (e.g., planar electrode(s)). In still other embodiments, the atom probe device 100 includes more, fewer, or different emitting devices 150; more, fewer, or different temperature control systems 116; and/or more, fewer or different electrical sources 112.

In selected embodiments, an atom probe process can be used to evaporate at least a portion of a specimen (e.g., formed from a portion of a structure). Data gathered during the evaporation process can be used to construct or form a three-dimensional data set and the data set can be used to represent at least part of the portion of the specimen that was evaporated. For example, this data set can then be used in other data processes and/or used in other types of data analysis. As used herein, a three-dimensional data set can include a three-dimensional representation of the arrangement of atoms and/or molecules that were in/on the portion of the specimen that was evaporated and can include the type of atoms/molecules (e.g., compositional data), the position or location of atoms/molecules, and/or the number of atoms/molecules. In certain embodiments, the data set constructed from the data gathered during the evaporation process can be processed to form one or more subsequent three-dimensional data sets that are more accurate, provide information about a selected specimen detail, and/or are better suited for subsequent data processing or data analysis.

In selected embodiments, the specimen can include a portion of various types of materials, assemblies, and/or structures, including various types of devices, composite materials, biological materials, and/or the like. In certain embodiments the specimen can include a portion of a microelectronic assembly. For example, a microelectronic assembly can include substrates that are used to form microdevices, including microelectronic devices. Typical microdevices include microelectronic circuits or components, thin-film recording heads, data storage elements, microfluidic devices, and other products. Micromachines and micromechanical devices are included within this definition because they are manufactured using much of the same technology that is used in the fabrication of integrated circuits. The substrates can be semiconductive pieces (e.g., doped silicon wafers, silicon germanium wafers, or gallium arsenide wafers), non-conductive pieces (e.g., various ceramic substrates), or conductive pieces. In some cases, the substrates can include flexible materials (e.g., flexible tape) and/or rigid materials. In selected embodiments a microelectronic device can include at least a portion of a semiconductor wafer or die.

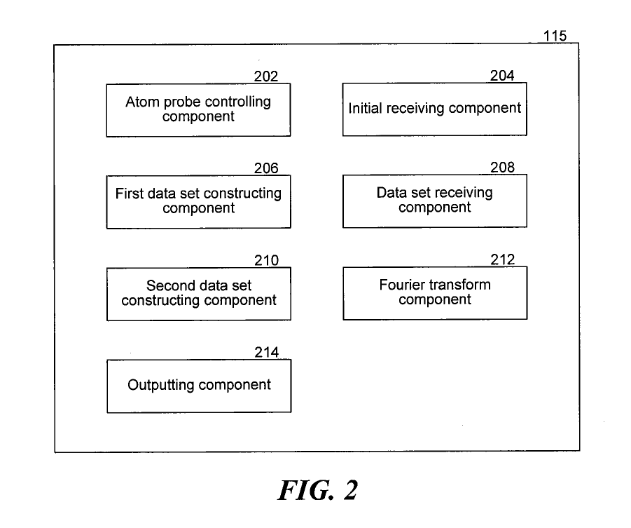

FIG. 2 is a partially schematic illustration of the computing system 115 shown in FIG. 1 in accordance with selected embodiments of the invention. In the illustrated embodiment, the computing system 115 includes an atom probe controlling component 202, an initial receiving component 204, a first data set constructing component 206, a data set receiving component 208, a second data set constructing component 210, a Fourier Transform component 212, and an outputting component 214. In other embodiments, the computing system 115 can include more, fewer, and/or different components.

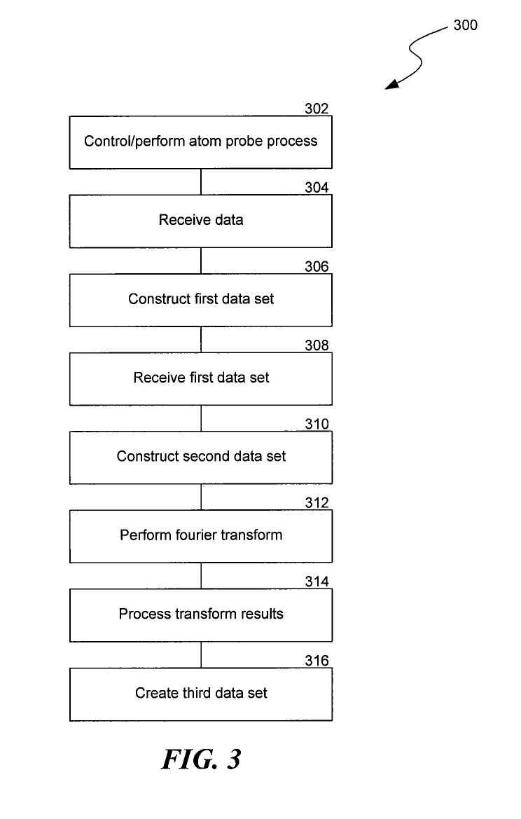

FIG. 3 is a flow diagram illustrating a method 300 for processing atom probe data gathered from evaporating a portion of a specimen in accordance with certain embodiments of the invention. For example, in selected embodiments atom probe data can be collected and used to form a first three-dimensional data set. The first data set can then be further processed to provide a second or modified three-dimensional data set that better represents the portion of the specimen or that is well suited for additional data processing/analysis. For example, in selected embodiments the second data set can be created from at least a portion of the first data set by moving the position of atoms/molecules in the portion of the first data set, adding atoms/molecules to the portion of the first data set, and/or removing atom/molecules from the portion of the first data set. In certain embodiments, the second data set can be constructed to correct errors in the original atom probe data and/or the first data set. In other embodiments the second data set can provide selected details about, or associated with, the structure (e.g., atomic/molecular structure) of the specimen. In still other embodiments, the second data set can be created to aid in visualizing, analyzing and/or processing data and information associated with the specimen. In yet other embodiments, at least a portion of the second data set can be processed to form a third three-dimensional data set that, for example, corrects errors in the second data set, provides selected details associated with the specimen, aids in visualization, and/or provides a format that can aid in further data analysis and/or processing.

In the illustrated embodiment, various portions of the computing system 115 (shown in FIG. 2) can be used to carry out the method 300 shown in FIG. 3. For example, in the illustrated embodiment the atom probe controlling component 202 runs or controls an atom probe process (process portion 302) to evaporate atoms from a portion of the specimen and collect time of flight and position data for the evaporated atoms. For example, as atoms are evaporated from the specimen the controlling component 202 can track the order in which the atoms are evaporated and hit the detector (e.g., collect chronological data). The controlling component 202 can also track the position where the evaporated atoms impact the detector, discussed above with reference to FIG. 1 (e.g., the two-dimensional position data associated with where the evaporated atoms hit the detector). Additionally, the time of flight data for the evaporated atom (e.g., the time it takes an evaporated atom to travel between the specimen and the detector) can be tracked by the controlling component 202. The chronological data, two-dimensional position data, time of flight data, and/or other data associated with the evaporation process (e.g., data or atom probe data) can be stored, for example, in a list.

In selected embodiments, the controlling component 202 can send the data (e.g., chronological data, two-dimensional position data, time of flight data, and/or other data associated with the evaporation process) to the initial receiving component 204. The initial receiving component 204 can receive the data (process portion 304). In other embodiments, the controlling component 202 can provide the data for receipt by the initial receiving component 204 in another form or via another process. For example, in selected embodiments the controlling component 202 can provide an operator or user a print out of the data or the data stored on a computer readable medium (e.g., stored on a disk), for example, via the outputting component 214. The operator or user can then provide the data to the initial receiving component 204 via the computer readable medium (e.g., inserting the disk into the initial receiving component 204).

The initial receiving component 204 can provide the data to the first data set constructing element 206. The first data set constructing element 206 can construct a first three-dimensional data set (process portion 306) from, or based on, the data received by the initial receiving component. For example, data from the evaporation of a portion of the specimen can be processed to form the first data set. Processing can include filtering the data, applying corrections for perceived specimen tip radius, applying corrections for evaporation energy levels, applying corrections for evaporation energy duration, assigning volumes to data points based at least in part on perceived mass-to-charge ratios, and/or the like. Accordingly, in selected embodiments the first data set can be a three-dimensional representation of the arrangement of atoms and/or molecules that were detected as the specimen was evaporated. For example, the first three-dimensional data set can include data elements (e.g., the atoms and/or molecules that were evaporated from the specimen) and a first data element structure (e.g., the position or arrangement of the data elements relative to one another or relative to a reference system, point, or grid). For instance, in selected embodiments the first three-dimensional data set can include a first three-dimensional map, a first three-dimensional array (e.g., numeric array), and/or the like.

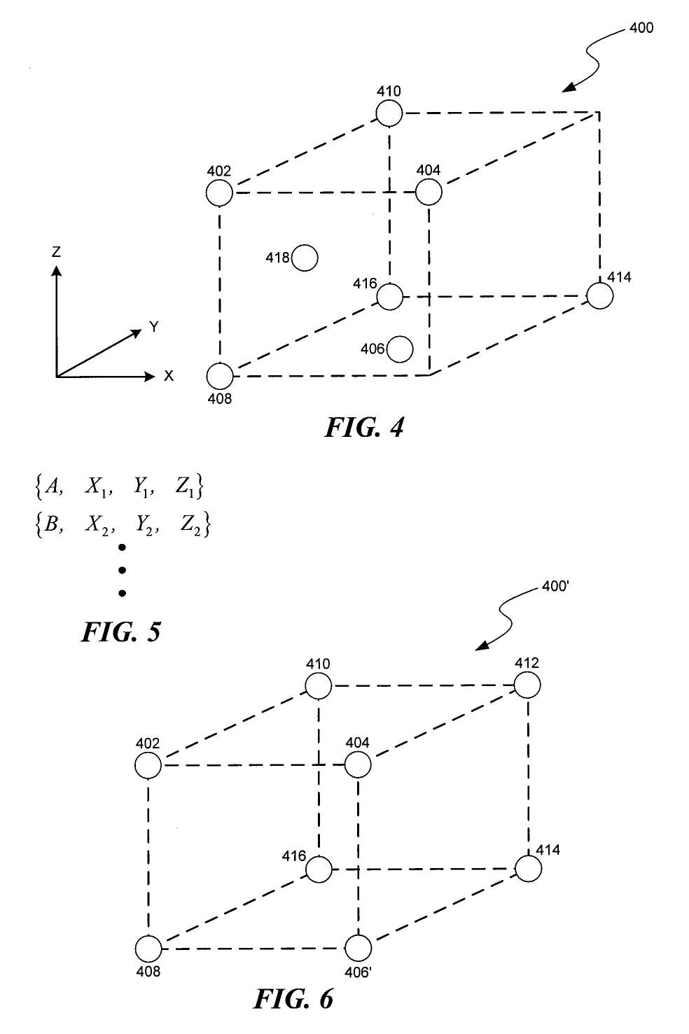

FIG. 4 is a partially schematic illustration of a portion of the first three-dimensional map that has been constructed or created from the atom probe data obtained via the evaporation of a portion of the specimen shown in FIG. 1 in accordance with selected embodiments of the invention. In FIG. 4, the first three-dimensional map depicts the position of various data elements 400, including a first data element 402, a second data element 404, a third data element 406, a fourth data element 408, a fifth data element 410, a sixth data element 414, a seventh data element 416, and an additional data element 418. FIG. 4 also includes an axes system (e.g., similar to the one shown in FIG. 1). Accordingly, in the illustrated embodiment the position of each data element relative the axes system and/or relative to one another can be represented in the first three-dimensional map (e.g., the map shows the first data element structure). Additionally, in selected embodiments the distance between the data elements can be determined. As discussed above, in certain embodiments the data elements can include compositional information (e.g., the type of atom(s) and/or molecule(s) included in each data element). In other embodiments, the compositional information is not presented or included (e.g., the data elements includes positional information associated with an atom or molecule, but does not include the composition of the atom or molecule).

FIG. 5 is a partially schematic illustration of a portion of the first three-dimensional numerical array representing a portion of the first three-dimensional map shown in FIG. 4. In FIG. 5, the data elements include compositional information (e.g., denoted as A, B, etc.) and positional information (e.g., denoted as X₁, Y₁, Z₁, X₂, Y₂, etc.). As noted above, in selected embodiments the data elements do not include compositional information. Additionally, in certain embodiments the positional information can include the position or location of the selected data element relative to a reference (e.g., relative to a reference grid, and/or as a vector and distance from a reference point) or relative to one or more other data elements. In still other embodiments, the data elements in the three-dimensional array can include other information associated with the data element (e.g., electrical charge information, distance between neighboring data element in addition to other positional information, and/or the like).

The first data constructing component 206 can provide the data set to a data set receiving component 208 (e.g., via a network or a portable computer readable medium) and the data set receiving component 208 can receive the data set (process portion 308). The data set receiving component 208 can then provide the data set to a second data set constructing component 210. The second data set constructing component 210 can construct or create a second three-dimensional data set from at least a portion of the first three-dimensional data set (process portion 310). In certain embodiments, the second data set can have a second data element structure that is different from the first data element structure. Additionally, in some embodiments the second data set can use a different frame of reference for positional information than was used by the first data set. For example, in selected embodiments the first data set's positional information can be referenced to an axes system and the second data set's positional information can be referenced to one or more selected data elements. In other embodiments, the first and second data sets can use the same frame of reference for positional information.

In selected embodiments the second data set constructing element 210 can create the second data set by changing or modifying the first data set based on a characteristic associated with the atom probe specimen. For example, in selected embodiments the second data set constructing element 210 can analyze at least a portion of the first data set and/or the atom probe data to determine a characteristic associated with the specimen. In other embodiments, a characteristic associated with the specimen can be provided (e.g., by an operator) or stored for use by the second data set constructing element 210. In selected embodiments, the characteristic can include compositional information (e.g., a composition of a portion of the specimen), an atomic arrangement (e.g., the position of atoms relative to one another and/or the distances between atoms), a molecular arrangement (e.g., the position of molecules relative to one another and/or the distances between molecules), and/or a lattice arrangement (e.g., a crystalline structure). For example, in some embodiments the characteristic can include an expected data element structure, a data element structure that will present data in a format that can provide a selected detail about the specimen, and/or be well suited for a selected data analysis process.

In certain embodiments, the second data constructing element 210 can create or construct the second data set by moving the position of a data element in a portion of the first data set, adding a data element to a portion of the first data set, and/or removing a data element from a portion of the first data set. For example, FIG. 6 shows a second three-dimensional map representing the second data set that has been constructed from at least a portion of the first data set (e.g., represented by the first three-dimensional map shown in FIG. 4). In the illustrated embodiment, based on the first data element structure of the first data set (e.g., one or more characteristics associated with the specimen), the second data set constructing element 210 has determined that the additional data element 418 (shown in FIG. 4) should be removed, the third data element 406 should be moved (e.g., to the location shown by 406′ in FIG. 6), and an eight data element 412 should be added to construct the second data set 400′. For example, in the illustrated embodiment the second data set constructing element 210 identified a re-occurring lattice structure in the first data set, associated the lattice structure with the data elements, and modified the first data element structure as discussed above, based on the associated lattice structure. In selected embodiment, a second data set can be constructed for the entire first data set or for only a portion of the first data set. In other embodiments, multiple second data sets can be constructed for multiple portions of the first data set.

In some embodiments, the second data set can have other forms. For example, in selected embodiments the second data set can be shown as a three-dimensional array, similar to the three-dimensional array shown in FIG. 5. Although in selected embodiments the second data set can include compositional information, in other embodiments the second data set does not include compositional information (e.g., even if the first data set included compositional information). As discussed above, in still other embodiments the second data set can use a different frame of reference for positional information than is used for the first data set. For example, in certain embodiments the second data set can be produced to show selected details about the general atomic/molecular structure of a portion of the specimen (e.g., a region of interest of the specimen). Accordingly, several portions of the first data set can be examined and used to produce one or more three-dimensional data sets (e.g., second data sets) of one or more structures that are generally contained in the portion of the specimen, without regard to the location of the structure within the portion of the specimen. In selected embodiments, because each second data set can be produced by examining multiple portions of the first data set, these second data set(s) can provide selected detail(s) about the atomic/molecular structure of the portion of the specimen that was/were not available from the first data set.

In selected embodiments, the composition and/or atomic/molecular structure (e.g., assumed, expected, and/or identified) can be used to modify a portion of a first data structure to form a second data structure. For example, if the first data set resembles an ordered alloy, the probability of selected data elements occupying selected locations in a lattice structure (e.g., this technique is suitable for specimens that include B2 NiAl or L1₂ Ni₃Al) can be determined. In other embodiments, the crystal structure of certain materials can aid in determining the probability that one or more selected impurities occupy interstitial sites or substitutional sites. For example, in certain embodiments with Fe based alloys C, P, or S atoms can be positioned in between the matrix atoms and/or replace Fe atoms in the matrix.

In still other embodiments, the atomic/molecular structure associated with a boundary between phases of different crystallographic structure can be determined by modifying a first data set using an expected atomic/molecular structure associated with the boundary to produce a second data set. In yet other embodiments, cluster analysis can be used to determine the atomic/molecular structure that should be used in forming a second data set. For example, in certain embodiments a “friends of friends” algorithm or a “maximum separation method” can be used to determine specific atom types that are/should be located within a certain distance of each other and/or are located at specific positions on a crystal lattice.

In selected embodiments, useful structural information can be obtained by directly imaging offsets between reconstructed neighbor positions (e.g., using a Nearest Neighbor Algorithm). In certain embodiments, position-dependent reconstruction aberrations can be estimated across much of the field of view of the specimen by direct examination of peak shapes in the resulting three-dimensional spatial distribution functions. For example, in selected embodiments for one or more selected atoms in a three-dimensional array, the relative positions of its nearest neighbors out to some arbitrary distance (e.g., 4 nm×4 nm×4 nm for an approximately 4000 atom data set) can be recorded as a three-dimensional histogram. The process can be repeated for all atoms in at least a portion of the array. When there is a periodic placement of atoms in the array, intensity maxima can appear in the three-dimensional histogram.

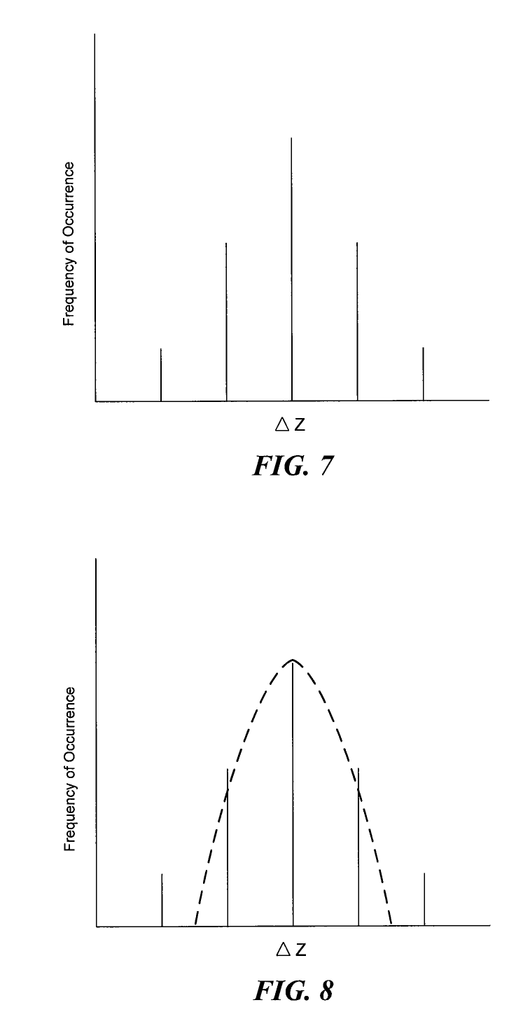

For example, FIG. 7 is a partially schematic illustration of a histogram associated with a portion of the first data set showing periodicity in a frequency of occurrence versus delta Z plot (e.g., a frequency of occurrence versus change in Z plot). The frequency of occurrence maxima can correspond to a heightened probability of finding a data element (e.g., an atom or molecule) at the location of the maximum. For crystals, the centroids of the maxima can correspond to data element positions in real space. The three-dimensional lattice can be identified from the loci of maxima in the histogram. The width of the maxima can be a measure of the average deviation from the lattice position. This deviation can vary with direction and location in the data and may be used as a measure of the spatial resolution in the dataset. Any angular deviation of the lattice axes can be a measure of the distortion of the data. In selected embodiments, this information may be used to modify a first data set to create a second data set. In certain embodiments, the length of the inter-lattice spacings can be scaled to known values for the crystal as a means of calibrating the reconstructed image from an atom probe.

In selected embodiments, the Fourier Transform component 212 can be configured to process at least a portion of the second three-dimensional data set using a Fourier Transform process (e.g., Fast Fourier Transform process, Discrete Fourier Transform process, etc.) to produce a third three-dimensional data set (e.g., that will present data in a format that can provide a selected detail about the specimen and/or be well suited for a selected data analysis process). For example, in selected embodiments the Fourier Transform component 212 can perform a Fourier Transform on a portion of the second data set (process portion 312) to produce a transform result. For instance, as shown in FIG. 8, a frequency of occurrence versus delta Z plot (e.g., similar to the histogram shown in FIG. 7) associated with the second data set can be formed. The Fourier Transform can be performed on at least a portion of the second data set (e.g., as illustrated by the dashed lines in FIG. 8). The transform result can be filtered (e.g., including being truncated) and/or otherwise processed (process portion 314). An inverse Fourier Transform can then be performed on the filtered or processed results to create, construct, or produce a third three-dimensional data set (process portion 316).

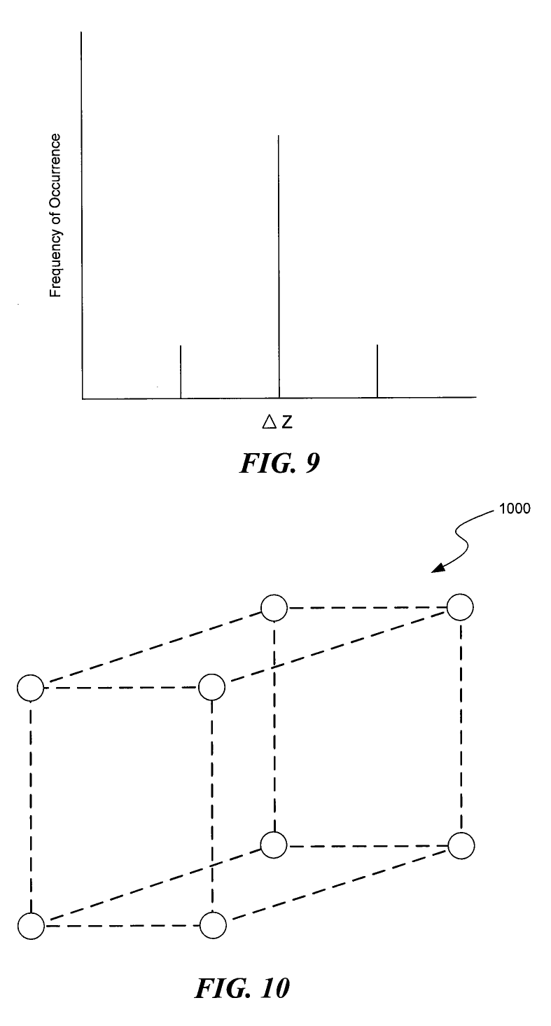

For example, FIG. 9 illustrates a histogram associated with the third data set after the inverse Fourier Transform process. FIG. 10 illustrates a corresponding three-dimensional map 1000 representing the third data set. As illustrated in FIG. 10, the third data set can have a third data element structure different from the first and second data element structures (e.g., illustrated in FIGS. 4 and 6, respectively). For example, in selected embodiments processing at least a portion of the second data set using a Fourier Transform to produce the third data set can result in data elements being moved, added, and/or removed from the data element structure associated with the second data set. For example, in the illustrated embodiment the data element structure in FIG. 10 has a different spacing between the data elements than the spacing shown in FIG. 6.

In other embodiments, the third data set can be depicted in other forms, including a three-dimensional array (e.g., similar to the array shown in FIG. 5). Additionally, in selected embodiments the third data set can depict positional data using the same frame of reference as the first and/or second data set. In other embodiments, the third data set can have a positional frame of reference different from the frame of reference used for the first or second frame of reference. For example, in certain embodiments the third data set can be produced to show selected details about the general atomic/molecular structure of a portion of the specimen (e.g., a region of interest of the specimen). Accordingly, several portions of the second data set can be used to produce one or more third data sets having one or more structures that are generally contained in a portion of the specimen, without regard to the location of the structure within the portion of the specimen.

Furthermore, in selected embodiments the third data set can include compositional information, while in other embodiments the third data set does not include compositional information (e.g., even if the first and/or second data set included compositional information). In selected embodiments, because each third data set can be produced from multiple portions of the second data set, these one or more third data set(s) can provide selected detail(s) about the atomic/molecular structure of the portion of the specimen that was/were not available from the second data set. In certain embodiments, the third data set can provide a data set with less noise than the corresponding portion of the second data set.

In selected embodiments, the second data set constructing component 210 can use a Fourier Transform process similar to that discussed above to create a second data set. In still other embodiments, the second data constructing component 210 and/or the Fourier Transform component 212 can be used to form subsequent three-dimensional data sets similar to the second and/or third data sets in an iterative process. In selected embodiments, this iterative process can provide a three-dimensional data set that presents data in a format that can provide a selected detail about the specimen (e.g., including increased positional information accuracy) and/or can be well suited for a selected data analysis/process.

The outputting component 214 can provide various outputs from various portions of the process described above. For example, in selected embodiments the outputting component 214 can display, print, and/or store various outputs or parameters, including the atom probe data, the first data set, the second data set, and/or the third data set. In other embodiments, the outputting component 214 can provide various outputs or parameters directly to other computing systems (e.g., via a network or a portable computer readable medium). Additionally, although many of the process portions described above have been discussed as being performed in a computing environment and/or as being automated, in other embodiments various portions can be performed manually and/or with various manual inputs. Additionally, many of the embodiments discussed above can have other arrangements and/or be practiced in other ways. For example, in selected embodiments the second data element structure of the second data set can be based on a characteristic that is not associated with a selected specimen. For instance, in selected embodiments the second data element structure of the second data set can be based on the atom probe process, including the associated components/characteristics of a selected a atom probe (e.g., the detector efficiency of a selected atom probe).

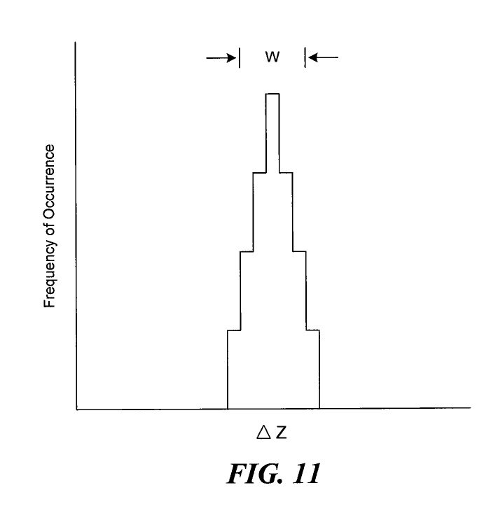

As discussed above, in some embodiments certain features can be used to process atom probe data and produce three-dimensional data sets that have increased accuracy, provide information about a selected specimen detail, and/or are well suited for subsequent data processing or data analysis. In selected embodiments, features discussed above can be used to correct or compensate for quantum detection efficiency and reconstruction artifacts, including detection errors or inefficiencies, smears, strains, shears, trajectory aberrations, other aberrations, noise, and/or the like. In certain embodiments, some of the process discussed above can be used to determine detector efficiencies and/or information about other atom probe components, atom probe processes, or both. In selected embodiments, various processes discussed above can be used to find the relative orientation of multiple crystals and/or the magnitude of the displacement across an interface of a specimen. In certain embodiments, the deviations from perfect crystal registration can be determined. In some embodiments, some of these processes can be applied to atomistic models to provide various types of information. For example, as shown in FIG. 11, in certain embodiments a width W of a maxima on a histogram associated with a three-dimensional data set can be a measured (e.g., at a selected point such as one half maxima, one third maxima, etc.). In some cases, this width can be related to (or an indication of) an atomic displacement amplitude (e.g., based on specimen temperature) or related to (or an indication of) a phonon amplitude (e.g., based on lattice vibration), or both.

From the foregoing, it will be appreciated that specific embodiments of the invention have been described herein for purposes of illustration, but that various modifications may be made without deviating from the invention. Additionally, aspects of the invention described in the context of particular embodiments may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

I/we claim:

1. A computing system configured to process atom probe data, comprising:
an atom probe controlling component configured to control an atom probe process to (a) evaporate atoms from the portion of the specimen and (b) collect time of flight and position data for the evaporated atoms;
an initial receiving component configured to receive the time of flight and position data;
a first data set constructing component configured to construct the first three-dimensional data set from at least a portion of the time of flight and position data, the first three-dimensional data set being a three-dimensional array;
a data set receiving component configured to receive the first three-dimensional data set, the first three-dimensional data set having a first data element structure; and
a second data set constructing component configured to create a second three-dimensional data set from at least a portion of the first three-dimensional data set by at least one of changing the location of a data element in the first three-dimensional data set, adding a data element to the first three-dimensional data set, and removing a data element from the first three-dimensional data set so that the second three-dimensional data set has a second data element structure different from the first data element structure.

2. The system of claim 1 wherein the second data element structure is based on a characteristic associated with the atom probe specimen, wherein the characteristic includes at least one of a composition, an atomic arrangement, a molecular arrangement, and a lattice arrangement associated with the first three-dimensional data set.

3. The system of claim 1, further comprising a Fourier Transform component configured to perform a Fourier Transform on a portion of the second three-dimensional data set to produce a transform result, to process the transform result, to perform an inverse Fourier Transform on the processed transform result to produce a third three-dimensional data set associated with the portion of the second three-dimensional data set.

4. The system of claim 1 wherein the specimen includes a portion of a microelectronic assembly.

5. A computing system configured to process atom probe data, comprising:
a data set receiving component configured to receive a first three-dimensional data set, the first three-dimensional data set having a first data element structure and being based on data collected from performing an atom probe process on a portion of an atom probe specimen; and
a data set constructing component configured to create a second three-dimensional data set having a second data element structure, the second data element structure being different than the first data element structure and being based on a characteristic associated with the (a) atom probe specimen, (b) the atom probe process, or (c) both (a) and (b).

6. The system of claim 5 wherein the data set constructing component includes a second data set constructing component, further comprising:
an atom probe controlling component configured to control an atom probe process to (a) evaporate atoms from the portion of the specimen and (b) collect time of flight and position data for the evaporated atoms;
an initial receiving component configured to receive the time of flight and position data; and
a first data set constructing component configured to construct the first three-dimensional data set from at least a portion of the time of flight and position data, the first three-dimensional data set being a three-dimensional array.

7. The system of claim 5 wherein the data set constructing component includes a second data set constructing component, further comprising:
an atom probe controlling component configured to control an atom probe process to (a) evaporate atoms from the portion of the specimen and (b) collect chronological data, two-dimensional position data, and time of flight data for the evaporated atoms;
an initial receiving component configured to receive the chronological data, two-dimensional position data, and time of flight data; and
a first data set constructing component configured to construct the first three-dimensional data set from at least a portion of the chronological data, two-dimensional position data, and time of flight data.

8. The system of claim 5 wherein the characteristic includes at least one of an atomic arrangement, a molecular arrangement, and a lattice arrangement associated with the first three-dimensional data set.

9. The system of claim 5 wherein the data set constructing component is configured to create a second three-dimensional data set from at least a portion of the first three-dimensional data set by removing a data element from the first three-dimensional data set.

10. The system of claim 5 wherein the data set constructing component is configured to create a second three-dimensional data set from at least a portion of the first three-dimensional data set by changing the location of a data element in the first three-dimensional data set.

11. The system of claim 5 wherein the data set constructing component is configured to create a second three-dimensional data set from at least a portion of the first three-dimensional data set by adding a data element to the first three-dimensional data set.

12. The system of claim 5 wherein the specimen includes a portion of a microelectronic assembly.

13. The system of claim 5, further comprising a Fourier Transform component configured to process at least a portion of the second three-dimensional data set using a Fourier Transform to produce a third three-dimensional data set.

14. The system of claim 5, further comprising a Fourier Transform component configured to perform a Fourier Transform on a portion of the second three-dimensional data set to produce a transform result, to process the transform result, to perform an inverse Fourier Transform on the processed transform result to produce a third three-dimensional data set associated with the portion of the second three-dimensional data set.

15. A method in a computing environment for processing atom probe data, comprising:
receiving a first three-dimensional data set, the first three-dimensional data set having a first data element structure and being based on data collected from performing an atom probe process on a portion of an atom probe specimen; and
creating a second three-dimensional data set having a second data element structure, the second data element structure being different than the first data element structure and being based on a characteristic associated with the (a) atom probe specimen, (b) the atom probe process, or (c) both (a) and (b).

16. The method of claim 15, further comprising:
controlling an atom probe process to (a) evaporate atoms from the portion of the specimen and (b) collect time of flight and position data for the evaporated atoms; and
constructing the first three-dimensional data set from at least a portion of the time of flight and position data, the first three-dimensional data set being a three-dimensional array.

17. The method of claim 15, further comprising:
controlling an atom probe process to (a) evaporate atoms from the portion of the specimen and (b) collect chronological data, two-dimensional position data, and time of flight data for the evaporated atoms; and
constructing the first three-dimensional data set from least a portion of the chronological data, two-dimensional position data, and time of flight data.

18. The method of claim 15 wherein the characteristic includes at least one of an atomic arrangement, a molecular arrangement, and a lattice arrangement associated with the first three-dimensional data set.

19. The method of claim 15 wherein the data set constructing component is configured to create a second three-dimensional data set from least a portion of the first three-dimensional data set by at least one of changing the location of a data element in the first three-dimensional data set, adding a data element to the first three-dimensional data set, and removing a data element from the first three-dimensional data set.

20. The method of claim 15, further comprising processing at least a portion of the second three-dimensional data set using a Fourier Transform to produce a third three-dimensional data set.
